(19) United States
(12) Patent Application Publication
(10) Pub. No.: US 2004/0115440 A1
(43) Pub. Date: Jun. 17, 2004

(54) Quartz glass component and method for the production thereof

(76) Inventors: Waltraud Werdecker, Hanau (DE); Rolf Gerhardt, Hammersbach (DE); Johann Leist, Altenstadt (DE)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 10/472,745

(22) PCT Filed: Mar. 20, 2002
(86) PCT No.: PCT/EP02/03118

(30) Foreign Application Priority Data
Mar. 23, 2001 (DE) 101146981

(51) Int. Cl. B32B 17/06

(52) U.S. Cl. 428/426; 428/432; 427/453

(57) ABSTRACT

Disclosed is a component made of quartz glass, especially a crucible. A blank is provided with a stabilizing layer exhibiting a higher softening temperature than quartz glass. In order to provide a quartz glass component which is characterized by high mechanical and thermal resistance, in addition to providing a simple, cost-effective method for the production of said component, the chemical composition of the stabilizing layer (3; 6; 7; 38) is different from that of the quartz glass and said layer is applied by means of heat injection. The inventive method is characterized in that a stabilizing layer (3; 6; 7; 38) whose chemical composition is different from that of quartz glass is applied by heat injection.

The present invention relates to a structural component of quartz glass of a high thermal stability, in particular a quartz glass crucible, comprising a base form of which at least a part of the outer surface thereof is provided with a stabilization layer having a higher softening temperature than quartz glass.

Furthermore, the present invention relates to a method of producing a structural component of quartz glass having a high thermal stability, in particular a quartz glass crucible, by producing a base form of the structural component and by providing at least a part of the outer surface thereof with a stabilization layer having a higher softening temperature than quartz glass.

Structural components of quartz glass are frequently used for manufacturing processes in which high purity is of importance. The temperature stability of quartz glass is here a limiting factor. Temperature values around 1150° C. are indicated in the literature as a lower softening point of quartz glass, However, it often happens that the necessary process temperatures are above said temperature, possibly resulting in plastic deformations of the structural components of quartz glass. The melting temperature during pulling of a single crystal from a silicon melt is e.g. around 1480° C. It has therefore been suggested that the thermal stability of quartz glass components should be increased by providing said components with a surface layer of cristobalite. The melting point of cristobalite is at about 1720° C.

A quartz glass crucible of such a design and a method of producing the same are known from EP-A 748 885. The vitreous outer wall of a commercially available quartz glass crucible is treated with a chemical solution containing substances that, acting as nucleating agents, are capable of promoting the devitrification of quartz glass to cristobalite. Alkaline-earth, boron and phosphorus compounds are suggested as crystallization-promoting substances. Barium oxide is preferably used. While the quartz glass crucible is heated up during the single-crystal growing process, the wall treated in this way crystallizes, thereby forming cristobalite. This crystallization of the outer wall results in a higher mechanical and thermal strength of the quartz glass crucible.

However, the crystallization of the inner or outer wall is only reproducible under great efforts because it is very difficult to control nucleation—because of the distribution of the crystallization-promoting substances on the crucible surface—and also crystal growth. During transportation or handling of the quartz glass crucible the crystallization-promoting substances may be rubbed off. Therefore, it is normally not foreseeable whether crystallization takes place in the predetermined manner, which can only be checked during use of the quartz glass crucible. Moreover, crystallization only starts in the course of the growing process, i.e. at a process stage in which a plastic deformation of the quartz glass crucible may already have taken place.

In a structural component and in a method of the above-mentioned type, as is known from U.S. Pat. No. 4,102,666, this drawback is largely avoided. It is suggested there that a stabilization layer should be produced for the thermal stabilization of a diffusion tube of quartz glass by spraying cristobalite powder onto the outer surface on the tube and by subsequently melting the powder with said surface. During melting, however, amorphous SiO₂, i.e. quartz glass, is normally formed at least in part from the crystalline phase. The degree of re-conversion into the amorphous phase depends on the duration of the melting process and on the degree of the melting temperature and is difficult to control in practice. A powder layer of cristobalite which has been molten to an insufficient degree tends to flake off, and the stabilizing effect of the cristobalite powder is lost in the case of excessive melting because of a conversion into the amorphous phase.

A further difficulty arises from the use of the known structural components in the form of quartz glass crucibles during single-crystal growing according to the Czochralski method. In this method a seed crystal with a predetermined orientation is dipped into the melt and then slowly pulled up. Seed crystal and melt are rotating in opposite directions. The surface tension between seed crystal and melt has the effect that a small amount of melt is removed together with the seed crystal, with the melt gradually cooling down and thereby solidifying into the continuously growing single crystal. However, it may happen that the seed crystal breaks off, so that the so-called “initiation process” must be started again. The time interval up to the single-crystal growing process proper may amount to several hours, so that the duration of the process is prolonged accordingly and the thermal and chemical load for the quartz glass crucible increases correspondingly.

It is the object of the present invention to indicate a structural component of quartz glass which is characterized by a high mechanical and thermal strength and to indicate a simple and inexpensive method for producing such a structural component.

As for the structural component, this object starting from the above-described structural component is achieved according to the invention in that the stabilization layer differs in its chemical composition from quartz glass, arid that it is produced by thermal spraying.

The structural component according to the invention comprises a base form having a surface of which at least a part is provided with a stabilization layer which differs in its chemical composition from quartz glass.

Said stabilization layer has two functions.

On the one hand, the stabilization layer is conducive to the thermal stability of the structural component. This is achieved on the one hand in that it has a higher softening temperature than quartz glass, and on the other hand in that the stabilization layer differs in its chemical composition from that of the quartz glass of the base form. The difference in the chemical composition has the effect that either no cristobalite phase is formed in the stabilization layer, or only a small amount of cristobalite nuclei, so that crack formation and weakening of the structure by cristobalite conversion are avoided.

Moreover, it has been found that the so-called “initiation behavior” of the melt is improved when the coated structural component is used as a quartz glass crucible for pulling a crystal. The initiation process of the crystal is prevented by vibrations of the melt. It can be assumed that due to a change in the chemical composition on the boundary surface between base form and stabilization layer the vibration characteristics is of the crucible are changed in such a way that the build-up of a resonant vibration could be rendered difficult or prevented and that the initiation process of the single crystal could be facilitated. Since the stabilization layer is already fully developed at the beginning of the pulling process, this advantageous effect is already observed at the beginning of the pulling process, which is decisive for the initiation behavior.

Furthermore, the stabilization layer is characterized in that it is produced by thermal spraying. Methods for producing layers by means of thermal spraying are generally known, said generic term encompassing the following established techniques: flame spraying, high-speed flame spraying, detonation spraying, plasma spraying, arc spraying. Stabilization layers with a defined structure, layer thickness and microstructure can be produced by thermal spraying.

The structural component is e.g. a quartz glass crucible for pulling crystals from the melt or a quartz glass bell for use in reactors for producing semiconductor components, or tubes, plates, etc. The stabilization layer should in general not influence the function proper of the structural component and is therefore formed on an appropriately suited part of the surface.

It has been found to be of advantage that the stabilization layer contains high-melting oxides, silicates, phosphates and/or silicides. Such a stabilization layer is characterized by high thermal stability and mechanical strength. It is possible by way of thermal spraying to produce such a stabilization layer with a defined structure, layer thickness and microstructure.

Preferably, the stabilization layer contains Al₂O₃ and/or mullite, hafnium oxide, tantalum oxide, zirconium silicate, molybdenum disilicide, rare-earth phosphates and oxides.

Such layers can be applied without cracks or gaps in a uniform manner to the quartz glass surface, and they are characterized by a high thermal and mechanical stability. Cerium and yttrium phosphate shall be mentioned as examples of rare-earth phosphates, and zirconium oxide as an example of a rare-earth oxide.

Expediently, the stabilization layer has a layer thickness ranging from 50 μm to 1000 μm. With layer thicknesses below 50 μm, the stabilizing effect of the stabilization layer is inadequate. As for layer thicknesses above 1000 μm, there is the risk of flaking off.

It has been found to be of advantage that the stabilization layer comprises a plurality of successive layers of a different chemical composition. The mechanical and thermal properties of the stabilization layer can be adapted to the specific requirements by means of a plurality of successive layers of a different composition. Moreover, it is thereby possible to successively adapt the differences in the coefficient of expansion of quartz glass and an outer layer of the stabilization layer through one or more intermediate layers.

It has here turned out to be particularly useful that the stabilization layer comprises a layer of mullite and a further outer layer of Al₂O₃. Mullite is a chemical compound of silicon dioxide and aluminum oxide which has a coefficient of expansion lying between that of quartz glass and Al₂O₃.

As for the method, the above-mentioned object starting from the above-mentioned method is achieved according to the invention in that a stabilization layer which differs in its chemical composition from quartz glass is applied by spraying as a stabilizing means.

According to the invention a stabilization layer is applied by thermal spraying onto at least a part of the outer surface of the base form. The application of layers by means of thermal spraying is an established technique which permits the production of completely integrated, gap-free and uniform layers of a higher softening temperature than quartz glass on a quartz glass surface. The term “thermal spraying” encompasses the following established techniques: flame spraying, high-speed flame spraying, detonation spraying, plasma spraying, arc spraying.

The stabilization layer is applied by thermal spraying onto the outer surface of the structural component already before the first intended use of the structural component. It is thereby ensured that the thermal stabilizing effect of the stabilization layer is directly developed during use of the structural component and not e.g.—as in the above-mentioned known method—only gradually during use of the structural component.

The effects of the stabilization layer on the thermal stability and on the “initiation behavior” of the melt during use of the structural component as a quartz glass crucible have been explained above in more detail with reference to the structural component according to the invention.

It has turned out to be advantageous when the stabilization layer is applied to an outer surface having a mean surface roughness Rₐ of at least 10 μm. This effects a toothed engagement of the stabilization layer with the outer surface, and ensures an excellent adhesion of the stabilization layer on the base form. The outer surface can be roughened mechanically, by grinding or blasting with sand or CO₂ pellets or by etching. The necessary surface roughness, however, may also follow from the process during the production of the base form. The value for the surface roughness Rₐ is determined according to DIN 4768.

A procedure in which the stabilization layer is produced by plasma spraying has turned out to be particularly useful. The production of layers by means of plasma spraying is an established technique by which layers of a defined density, thickness and structure can be applied to the base form in a simple way.

In an alternative and equally preferred variant of the method, the stabilization layer is produced by flame spraying. Defined layers can thereby also be produced in a reproducible way on the base form; the starting material for the stabilization layer may here be present in powder or wire form in the case of flame spraying.

It has been found to be of advantage when a stabilization layer containing oxides and/or silicates, phosphates, suicides is produced. Preferably, the stabilization layer contains Al₂O₃ and/or mullite, hafnium oxide, tantalum oxide, zirconium silicate, molybdenum disilicide, rare-earth phosphates, rare-earth oxides. These are high-melting substances contributing to the thermal stability of the stabilization layer. Cerium phosphate (melting point 2056° C.) and yttrium phosphate (melting point 1995° C.) are preferably used as rare-earth phosphates.

Expediently, a stabilization layer is produced at a layer thickness ranging from 50 μm to 1000 μm. At a layer thickness of less than 50 μm, the stabilizing effect of the stabilization layer is not noticeable to an adequate degree, whereas layers with a layer thickness of more than 1000 μm might create thermal stresses and are, in addition, disadvantageous under economic aspects.

Particularly preferred is a variant of the method in which a composite powder is used as the starting material for producing the stabilization layer. The composite powder may e.g. be a powder in which a first material is enclosed by a second material and shielded by said second material towards the outside. It is e.g. possible by way of such a shield to use a substance as the first inner material that, otherwise, would sublime during plasma spraying or flame spraying. Nitrides, such as silicon nitride, should be mentioned as an example of such easily sublimable substances.

It has turned out to be of particular advantage when at least two starting materials of a different chemical composition are used for producing the stabilization layer. The chemical composition and thus the chemical and physical characteristics of the stabilization layer can thereby be varied in a particularly simple way. For instance, a gradient can be set in the coefficient of expansion.

It has turned out to be of advantage when a plurality of successive layers with a different chemical composition are applied to the outer surface for producing the stabilization layer. For instance, differences in the coefficient of expansion between the quartz glass of the base form and a further outwardly located layer of the stabilization layer can successively be bridged by this variant of the method. It has turned out to be particularly useful to produce a mullite layer which is surrounded by an Al₂O₃ layer.

The invention shall now be explained in more detail with reference to embodiments and a patent drawing. The drawing is a schematic illustration showing in detail in:

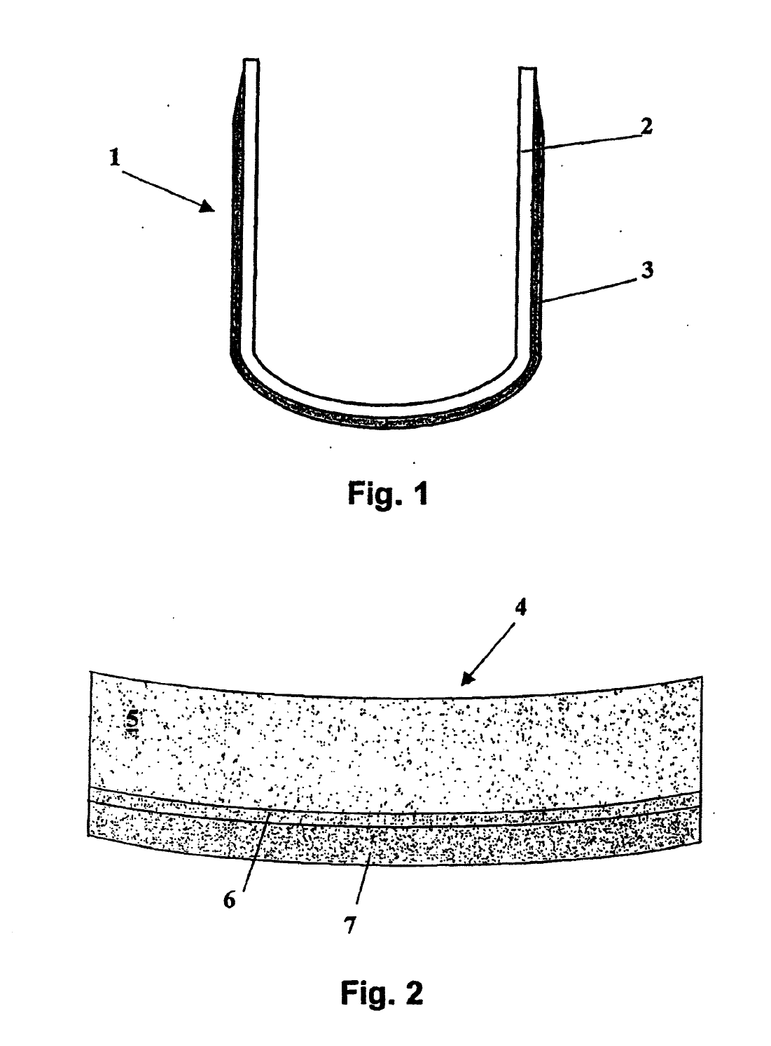

FIG. 1 a section through the wall of a quartz glass crucible with a stabilization layer;

FIG. 2 a partial section through the wall of a quartz glass tube with a stabilization layer; and

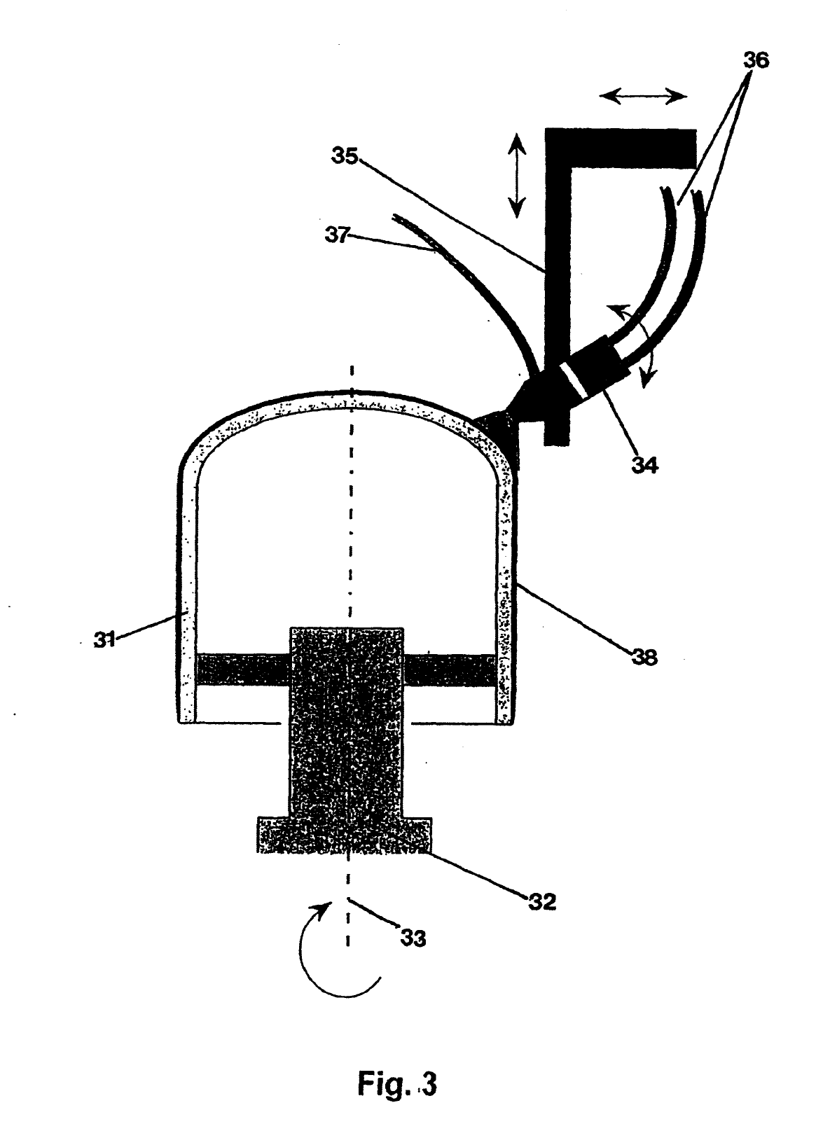

FIG. 3 an apparatus suited for carrying out the method according to the invention.

The stabilization layers which are essential for the invention are highlighted with respect to their thickness in FIGS. 1 to 3 for the purpose of a clear illustration; the illustrations are therefore not true to scale.

In FIG. 1, reference numeral 1 is assigned to a crucible on the whole. The crucible 1 consists of a base form 2 of opaque quartz glass whose outer wall is provided in the bottom area of the crucible 1 and in the side area with a tight, crack-free Al₂O₃ layer 3. The Al₂O₃ layer 3 has a mean thickness of about 500 μm. An embodiment of the method according to the invention shall now be explained in more detail with reference to the production of the crucible 1 according to FIG. 1. In a first step of the method, a base form of the quartz glass crucible is produced according to the known method. To this end, granules of natural quartz are filled into a metallic melt mold which rotates about its central axis, and a quartz granule layer of a uniform thickness is formed by means of a start template on the inner side of the melt mold and is stabilized by centrifugal forces on the inner wall, and is molten under continuous rotation by means of an arc which is lowered from above into the melt mold. The quartz granule layer is thereby molten forming the base form 2 as shown in FIG. 1. The base form 2 produced in this way has a dense inner surface layer which is characterized by a high mechanical, thermal and chemical strength. The outer wall of the base form 2 is freed from adhering quartz granules and then ground, resulting in a mean surface roughness Rₐ of about 50 μm.

In a second step of the method, the Al₂O₃ layer 3 is produced by means of plasma spraying on the outer wall of the base form prepared in this way. To this end, the crucible 1 is mounted on a holding device which engages into the crucible 1 and is rotatable about an axis of rotation, as will be explained in more detail further below with reference to FIG. 3. Al₂O₃ is sprayed onto the outer wall by means of a commercial plasma spray gun under rotation of crucible 1 about its central axis. The nozzle of the plasma spray gun is formed by a cathode which tapers towards the nozzle opening and is surrounded by a cylindrical anode. The coating material is supplied to the nozzle in the form of finely divided Al₂O₃ and is ionized, evaporated or molten by means of the plasma gas (argon with an addition of hydrogen) in an arc discharge at current densities of about 100 A/mm², and sprayed at a high speed towards the outer wall of the crucible. The temperature inside the plasma reaches values around 20,000° C., but rapidly decreases to the outside. The evaporated, molten and ionized particles are flung by means of the plasma beam onto the outer wall of the crucible where they solidify and form a thick Al₂O₃ coating which is firmly bound in itself. Plasma spraying will be concluded as soon as an approximately uniform layer thickness of the Al₂O₃ coating of about 500 μm has been reached.

The quartz glass tube 4 according to FIG. 2 comprises a base layer 5 of opaque quartz glass which encloses the inner hole and which is surrounded by a mullite layer 6, the latter being surrounded by an Al₂O₃ layer 7. The mullite layer 6 has a thickness of 50 μm, and the layer thickness of the Al₂O₃ layer 7 is 300 μm. The mullite layer 6 and the Al₂O₃ layer 7 are mechanically stable, crack-free layers which have been produced by flame spraying and form the individual layers of a stabilization layer in the sense of this invention.

A further embodiment of the method according to the invention shall now be explained in more detail with reference to the production of the tube according to FIG. 2.

In a first step of the method, crystalline granules of natural quartz with a grain size of 90 to 315 μm are purified by means of hot chlorination and filled into a tubular metal mold which rotates about its longitudinal axis. Under the action of the centrifugal force and with the help of a template, a rotationally symmetrical hollow cylinder is formed from the feed on the inner wall of the metal mold. The hollow cylinder has a layer thickness of about 100 mm in the feed and an inner hole in the form of a through hole with a diameter of about 180 mm. The feed is slightly compacted by the centrifugal force prior to the performance of the subsequent method steps.

In a second step of the method, the mechanically precompacted hollow cylinder is molten zonewise by means of an arc, starting from the inner hole. To this end a pair of electrodes is introduced into the inner hole, starting from an end of the hollow cylinder, and is continuously moved to the opposite end of the hollow cylinder. The granules are molten by the temperature of the arc. A maximum temperature of more than 2100° C. is reached on the inner wall of the hollow cylinder. A melt front which progresses to the outside towards the metal mold is thereby formed. The melting process is completed before the melt front reaches the metal form.

The tube of opaque quartz glass produced in this way is removed from the metal mold, ground and then etched in hydrofluoric acid and elongated in a hot forming step under reduction of the wall thickness (third step of the method). After the elongation process, the outer diameter is 245 mm and the inner diameter 233 mm. The outer lateral surface is blasted with frozen CO₂ pellets and a surface roughness Rₐ of 50 μm is thereby produced. This tube forms the base layer 5 of opaque quartz glass in the quartz glass tube 4 according to FIG. 2. Especially with such thin-walled tubes as in this embodiment, the stabilization layer has a particularly advantageous effect.

In a forth step of the method, the tube pretreated in this way is provided by means of flame spraying with the mullite layer 6. The coating process is carried out by analogy with the procedure explained above in more detail with reference to FIG. 1 so as to produce the Al₂O₃ layer 3, but use is made of a conventional powder flame-spraying technique. The mullite powder is here molten by means of a powder conveying unit with a conveying gas in an acetylene oxygen flame and is accelerated by the expansion of the acetylene oxygen mixture created during combustion, and is flung onto the tube surface to be coated. The mullite layer 6 produced in this way is homogeneous and crack-free and is characterized by a high mechanical strength.

In a further step of the method, the outer Al₂O₃ layer 7 is applied to the mullite layer 6 according to the same coating method (flame spraying using an acetylene oxygen flame). The mullite layer 6 effects a gradual transition of the expansion coefficient of the opaque quartz glass of the base layer 5 and the Al₂O₃ layer 7, thereby contributing to a high mechanical stability of the stabilization layer on the whole.

FIG. 3 schematically shows an apparatus which for applying a stabilization layer to the outer wall of a quartz glass crucible 31 is mounted on a clamping device 33 which can be rotated around the central axis 32 of the quartz glass crucible 31. Outside the quartz glass crucible 31, a flame spraying nozzle 34 is fixed on a holder 35 which is movable in horizontal and vertical direction. In addition, the flame spraying nozzle 34 is tiltable so that it can reach each position of the outer wall of the crucible. The flame spraying nozzle 34 is connected to a supply means 36 for acetylene and oxygen and to a feed line 37 for Al₂O₃ powder. The stabilization layer 38 is applied by means of the flame spraying nozzle 34 to the outer wall of the quartz glass crucible 31 which is rotating around the central axis 33. Stabilization layers of a predetermined thickness and of different starting materials can be produced without any great efforts by means of the apparatus which is schematically illustrated in FIG. 3.

1. A structural component of quartz glass of a high thermal stability, in particular a crucible, comprising a base form of which at least a part of the outer surface thereof is provided with a stabilization layer having a higher softening temperature than quartz glass, characterized in that said stabilization layer (3; 6; 7; 38) differs in its chemical composition from quartz glass, and that it is produced by thermal spraying.

2. The structural component according to claim 1, characterized in that said stabilization layer (3; 6, 7; 38) contains oxides, silicates, phosphates and/or silicides.

3. The structural component according to claim 2, characterized in that said stabilization layer (3, 6; 7; 38) contains Al₂O₃ and/or mullite, hafnium oxide, tantalum oxide, zirconium silicate, rare-earth phosphates, rare-earth oxides.

4. The structural component according to any one of the preceding claims, characterized in that said stabilization layer (3, 6, 7; 38) has a layer thickness ranging from 50 μm to 1000 μm.

5. The structural component according to any one of the preceding claims, characterized in that said stabilization layer comprises a plurality of successive layers (6;7) of a different chemical composition.

6. The structural component according to claim 5, characterized in that said stabilization layer includes a layer (6) of mullite and a further outer layer (7) of Al₂O₃.

7. A method of producing a structural component of quartz glass of a high thermal stability, in particular a quartz glass crucible, wherein a base form of said structural component is produced and at least a part of the outer surface thereof is provided with a stabilization layer having a higher softening temperature than quartz glass, characterized in that a stabilization layer (3; 6; 7; 38) differing in its chemical composition from quartz glass is applied by thermal spraying.

8. A method according to claim 7, characterized in that said stabilization layer (3; 6; 7; 38) is applied to a surface having an average surface roughness Rₐ of at least 10 μm.

9. The method according to any one of the preceding method claims, characterized in that said stabilization layer (3) is produced by plasma spraying.

10. The method according to any one of claims 7 to 9, characterized in that said stabilization layer (6; 7; 38) is produced by flame spraying.

11. The method according to any one of the preceding method claims, characterized in that a stabilization layer (3, 6; 7; 38) containing high-melting oxides and/or silicates, phosphates, silicides is produced.

12. The method according to claim 11, characterized in that said stabilization layer (3, 6; 7, 38) contains Al₂O₃ and/or mullite, hafnium oxide, tantalum oxide, zirconium silicate, rare-earth phosphates, rare-earth oxides.

13. The method according to any one of the preceding method claims, characterized in that a stabilization layer (3, 6; 7, 38) is produced with a layer thickness ranging from 50 μm to 1000 μm.

14. The method according to any one of the preceding method claims, characterized in that a composite powder is used for producing said stabilization layer.

15. The method according to any one of the preceding method claims, characterized in that at least two starting materials of a different chemical composition are used for producing said stabilization layer.

16. The method according to any one of the preceding method claims, characterized in that a plurality of successive layers (6; 7) of a different chemical composition are applied to said outer surface for producing said stabilization layer.

17. The method according to claim 15, characterized in that a mullite layer (6) is produced which is surrounded by an Al₂O₃ layer (7).
